(19) United States
(12) Patent Application Publication
(10) Pub. No.: US 2026/0116628 A1
(43) Pub. Date: Apr. 30, 2026

(54) HINGED CLOSURE

(71) Applicant: ALPLA WERKE ALWIN LEHNER GMBH & CO. KG, Hard (AT)

(72) Inventor: Georg SUESS, Raabs an der Thaya (AT)

(21) Appl. No.: 19/473,887

(22) PCT Filed: Apr. 11, 2024
(86) PCT No.: PCT/EP2024/059781

§ 371 Date: Oct. 9, 2025

(30) Foreign Application Priority Data
Apr. 14, 2023 (CH) CH000390/2023

(51) Int. Cl. B65D 47/08; B29C 45/00; B29C 45/18; B29C 45/36; B29K 23/00; B29L 31/22

(52) U.S. Cl. CPC B65D 47/0838; B29C 45/0001; B29C 45/1866; B29C 45/36; B29C 2045/363; B29K 2023/065; B29K 2023/12; B29L 2031/22

(57) ABSTRACT

A hinged closure which is molded from plastic and includes a cap which is fastenable to a neck of a container and which has a casing, a cover plate adjoining the casing, a retaining skirt protruding from the inner side of the cover plate, and a dispensing opening provided on the cover plate; and a hinged lid operatively coupled to the cap by a joint and having a sealing nipple on its inner side, which hinged lid is pivotable by means of the joint between a closure and an open position and snaps into place in both the positions. The hinged lid, the joint, the retaining skirt, and at least a first part of the cover plate are injection-molded from a first plastic. At least the casing is injection-molded from a second plastic, and the first and the second plastics are integrally bonded together at their transition.

### FIELD OF THE INVENTION

The invention relates to a hinged closure according to the preamble of claim 1, to a method according to claim 12, and to an injection mold according to the preamble of claim 14.

### PRIOR ART

A hinged closure is usually understood to be a closure having a cap and a hinged lid connected articulatedly to the cap. The hinged lid can be pivoted or snapped between two positions, viz., a closure position and an open position. To allow this function, it is known to use two tension straps and a central connection piece to form the articulated connection between the cap and the hinged lid. The joint, realized by the two tension straps and the central connection piece, thus exhibits active behavior in which the hinged lid opens and closes automatically when a defined limit is exceeded.

However, an active hinge requires specific material properties, since the plastic used cannot be too elastic. Otherwise, the tension straps are stretched too much, and the activity of the hinged closure is lost. In the prior art, polypropylene is preferably used to produce a hinged closure as described above.

Since PCR (post-consumer recycled) plastics are used in many fields for the production of containers, it would be desirable to be able to also use PCR material for the production of hinged closures. However, post-consumer recycled plastics do not have the necessary material properties to provide an active hinge.

### OBJECT OF THE INVENTION

The disadvantages of the prior art described result in the object of creating a hinged closure in which PCR plastic can be used.

### DESCRIPTION

The stated object, for a flip-top closure, is achieved by the features stated in the characterizing portion of claim 1. The dependent claims relate to developments and/or advantageous alternative embodiments.

The invention is preferably characterized in that the hinged lid, the joint, the retaining skirt, and at least a first part of the cover plate are injection-molded from a first plastic and at least the casing is injection-molded from a second plastic, and the first and the second plastics are integrally bonded to one another at their transition. The two-component design of the hinged closure means that only those elements of the hinged closure that require the functionality of a virgin plastic are injection-molded from a first virgin plastic. The other parts can be injection-molded from a cheaper, second plastic, in particular a PCR plastic. After the two-component injection-molding process, the two plastics flow into each other or fuse together, whereby they are reliably integrally bonded in the injection mold and can no longer be separated.

In a particularly preferred embodiment of the invention, the second plastic is a post-consumer recycled (PCR) plastic. This allows a region of the hinged closure that places lower demands on the plastic properties (casing and part of the cover plate) to be made from a recycled plastic.

Expediently, the first plastic is a virgin, non-recycled plastic which fulfills all the material properties of the hinged closure, in particular an active joint and a retaining skirt which can be snapped onto a container. Polypropylene has proven to be a suitable virgin plastic.

Advantageously, the first part of the cover plate is dimensioned such that the retaining skirt lies within the first part, and the joint adjoins the first part. This means that the first part of the cover plate, which has to be made of a virgin plastic because of the retaining skirt underneath, is as small as possible, and a second part of the cover plate can be injection-molded from PCR plastic.

In a further preferred embodiment of the invention, the cover plate has a second part which encloses the first part. This means that the second part is as large as possible and is reliably integrally bonded to the first part.

Advantageously, the second part of the cover plate is injection-molded from the second plastic, whereby an as large a proportion of the hinged closure as possible can be made from inexpensive PCR plastic.

In a further preferred embodiment of the invention, the first and the second parts of the cover plate are integrally bonded to one another at their contact point. The two-component injection-molding process is used for this purpose. At their transition, the two plastics fuse together, creating an indissoluble bond. The connection can additionally be form-fitting or frictional.

It has proven to be advantageous if the first plastic has a first color, and the second plastic has a second color which is different from the first color. This can give the consumer a visual indication of the use of a PCR plastic and makes it evident how much recycled plastic has been used to produce the hinged closure.

Expediently, the joint is realized by two tension straps and a central connection piece, the first ends of which are formed on the casing and the second ends of which are formed on the hinged lid. The lengths of the tension straps and the central connection piece are dimensioned in such a way that the joint is active, and the hinged lid is fixed in the open and closure positions. An active joint of this kind is known as a butterfly joint.

In a preferred embodiment of the invention, the first plastic consists of virgin HDPE or virgin PP. In principle, virgin polypropylene is preferred for reliable functioning of an active joint; however, there already exist solutions with a functioning joint made of high-density polyethylene.

In a further particularly preferred embodiment of the invention, the second plastic consists of a PCR-HDPE or a PCR-PP. This means that, surprisingly, as large a proportion of the hinged closure as possible can be made from recycled plastic without restricting or impairing the function of the hinged closure. In principle, PCR-PP is used for the second plastic if the first plastic is virgin PP, and PCR-HDPE is used for the second plastic if the first plastic is virgin HDPE. However, in the context of this invention, a combination of HDPE and PP is also not excluded.

A further aspect of the invention relates to a method for producing the hinged closure. In the method, in an injection mold having a die, a mold core, and a cavity formed between the die and the core, which cavity constitutes the negative impression of the hinged closure, a first core retraction insert and a second core retraction insert are retracted into a front position and sealingly abut the mold core, thereby preventing the filling of the cavity of the hinged lid, the joint, the retaining skirt, and at least a first part of the cover plate. The accessible regions of the cavity, which form at least the casing of the hinged closure, are filled with the second molten plastic. As a result, at least the casing and optionally a second part of the cover plate are injection-molded. The first and the second core retraction inserts are then retracted to a rear position, and the unfilled part of the cavity is filled with the first molten plastic, thereby injection-molding the hinged lid, the joint, the retaining skirt, and at least a first part of the cover plate and optionally the entire cover plate. The first and the second plastics are integrally bonded to one another at their common contact point, and the cured, two-component hinged closure is demolded from the injection mold. The first core retraction insert acts, in the front position, as an injection-molding core for the first part of the cover plate. The second core retraction insert, in its front position, closes the channel for filling the cavity of the hinged lid. The core retraction inserts, which are also called slides or shut-off slides, allow the production of a two-component hinged closure with a precise separation of the elements that require a virgin plastic from the elements that can be produced with a PCR plastic.

Another aspect of the invention relates to an injection mold for producing the hinged closure, having a first core retraction insert and a second core retraction insert which can be moved between a front and a rear position and prevent the filling of the cavity of the hinged lid, the joint, the retaining skirt, and at least a part of the cover plate in their front positions. This allows first the cavity of the casing and a second part of the cover plate to be injection-molded with a PCR plastic. Thus, all elements for which recycled plastic is suitable are made from PCR plastic.

In a further preferred embodiment of the invention, the first core retraction insert in the front position sealingly abuts the mold core. As a result, the cavity of the first part of the cover plate is reliably sealed, and no second plastic can penetrate into cavities intended to be filled with the first plastic.

It is particularly preferred if the second core retraction insert in the front position closes the channel between the cavity of the cap and the cavity of the hinged lid, and in the rear position opens said channel. This allows the hinged lid and the joint to be injection-molded specifically with the first plastic without the second plastic penetrating into the cavity of the joint and the hinged lid beforehand.

Further advantages and features will become apparent from the following description of an embodiment of the invention with reference to the schematic drawings. In the figures, in a representation that is not to scale:

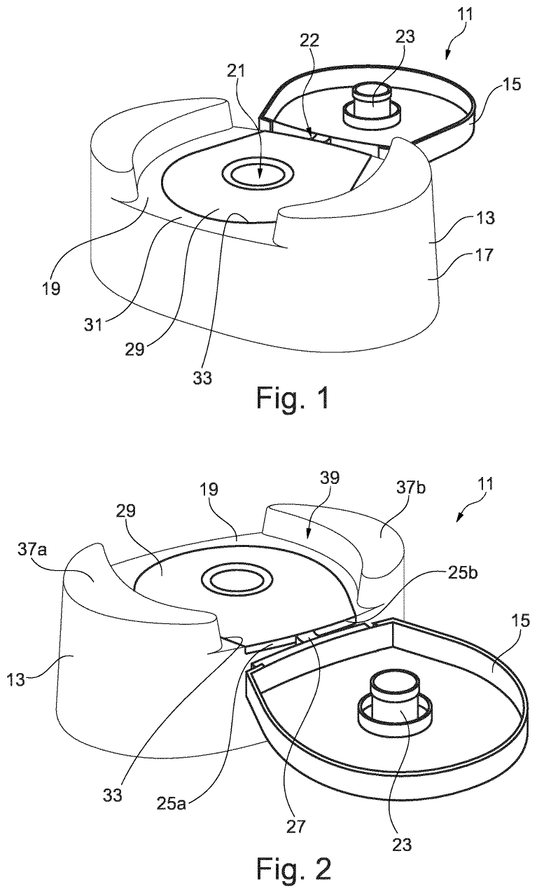

FIG. 1 is a first isometric view of a hinged closure with an open hinged lid from the front at an angle;

FIG. 2 is a second isometric view of the hinged closure from the rear at an angle;

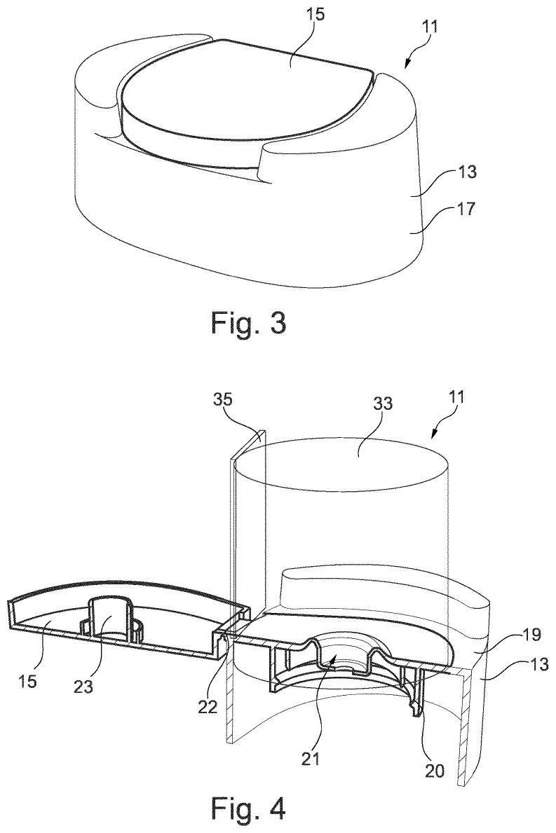

FIG. 3 is an axonometric view of the hinged closure with the hinged lid closed; and

FIG. 4 is an axonometric sectioned view of the hinged closure with a first and second stylized core retraction insert.

FIG. 1 to 4 show a hinged closure that is denoted as a whole by reference sign 11 and is produced in an injection mold. The closure 11 has a cap 13 which can be fastened to a neck of a container and a hinged lid 15 which is connected articulatedly to the cap. The cap 13 can, for example, be screwed onto the container neck or can be latched onto it.

The cap 13 has a casing 17, a cover plate 19 adjoining the casing 17, and a retaining skirt 20 protruding from the inner side of the cover plate 19. By means of the retaining skirt 20, the hinged closure 11 can be screwed or latched onto a container. Accordingly, the retaining skirt 20 has on its inner side an internal thread or latching elements. A dispensing opening 21 is provided in the cover plate 19 to enable the contents to be dispensed from the container.

The hinged lid 15 is connected to the cap 13 by a joint 22. On the inner side of the hinged lid 15, a sealing nipple 23 is provided, which interacts sealingly with the dispensing opening 21 when the closure 11 is closed. The hinged lid 15 can be pivoted between a closure position and an open position via the joint 22 and snaps into place in both positions.

The joint can be realized by two tension straps 25a, 25b and a central connection piece 27. The first ends of the tension straps 25a, 25b and of the central connection piece 27 are formed on the casing 17, and their second ends are integrally formed on the hinged lid 15. The interaction of the tension straps 25a, 25b and of the central connection piece 27 makes it possible for the hinged lid 15 to snap into the open position and the closure position. The joint therefore exhibits active behavior by opening and closing automatically when a defined tension is exceeded.

The hinged lid 15, the joint 22, the retaining skirt 20, and at least a first part 29 of the cover plate 19 are injection-molded from a first plastic. Preferably, the plastic is a virgin, non-recycled plastic, since only such a plastic meets the high functional requirements of the aforementioned hinged-closure parts, in particular of an active joint 22.

At least the casing 17 is injection-molded from a second plastic. The cover plate 19 can consist entirely of the first plastic. However, it is preferred if a second part 31 of the cover plate is injection-molded from the second plastic. The second plastic is preferably a post-consumer recycled (PCR) plastic. This means that the hinged closure can be partly made of PCR plastic, wherein exactly the parts of the hinged closure that have lower material requirements are injection-molded from PCR plastic. As a result, the hinged closure 11 has a flawless joint function and still contains an as large a proportion as possible of PCR plastic. In order to maximize the proportion of PCR plastic, the second part 31 is dimensioned as large as possible. However, a limit is set by the diameter of the retaining skirt 22. In order for the retaining skirt to be made of the first plastic, the first part 29 must have at least the diameter of the retaining skirt.

The first and the second plastics are fused together at their transition or at the contact point of the first and second parts 29, 31. The line of contact 32 is partly indicated in FIGS. 1 and 2. It is understood that the first and the second plastics can have different colors. This allows the consumer to be shown clearly how large the proportion of PCR plastic is in the hinged closure according to the invention.

The hinged closure 11 is produced in an injection mold which, in a known manner, has a die, a mold core, and a cavity formed between the die and the core. The cavity constitutes the negative impression of the hinged closure.

The injection mold is equipped with a first core retraction insert 33 and a second core retraction insert 35, which can be moved between a front and a rear position. In the front position, the first core retraction insert 33 sealingly abuts the mold core. In the front position, the second core retraction insert 35 closes the channel between the cavity of the cap 13 and the cavity of the hinged lid 15. In the rear position, the second core retraction insert 35 opens this channel.

If the two core retraction inserts 33, 35 are in the front position, the filling of the cavity of the hinged lid 15, the joint 22, the retaining skirt 20, and at least the first part 29 of the cover plate 19 is prevented. The accessible regions of the cavity are filled with the PCR plastic, and the casing 17 and preferably the second part 31 of the cover plate 19 are injection-molded. As a result, an as large a proportion as possible of the hinged closure is made of PCR material.

After the two core retraction inserts are retracted to the rear position, the unfilled part of the cavity is filled with the first molten plastic, whereby the hinged lid, the joint, the retaining skirt, and at least the first part 29 of the cover plate 19 are injection-molded. Through the opened channel, which is opened by the second core retraction insert 35, the first plastic can fill the joint 22 and then flow via the channel into the cavity of the hinged lid 15.

The first and the second plastics are combined using the two-component injection-molding process, in which the two plastics flow into each other and form an integral bond. A form-fitting or frictional connection by specially designed transitions of the plastic transition is also conceivable.

Finally, the two-component hinged closure is demolded from the injection mold.

A first and second step 37a, 37b can be formed on the edge of the cover plate 19. The hinged lid is received in its closure position in the depression 39 formed between the first and second steps 37a, 37b. The hinged lid is well protected between the steps, preventing it from being opened accidentally.

In principle, PP is preferred for joints because it has less elasticity than HDPE. However, hinges for HDPE are already being developed too. Therefore, PP and HDPE are conceivable for both the PCR plastic (second plastic) and the virgin plastic (first plastic). Mixing PP and HDPE is also not excluded (e.g., virgin PP and PCR-HDPE).

### LIST OF REFERENCE SIGNS

11 Hinged closure
13 Cap
15 Hinged lid
17 Casing
19 Cover plate
20 Retaining skirt
21 Dispensing opening
22 Joint
23 Sealing nipple
25a, 25b Tension straps
27 Central connection piece
29 First part of the cover plate
31 Second part of the cover plate
32 Line of contact
33 First core retraction insert
35 Second core retraction insert
37 First step and second step
39 Depression

1.-16. (canceled)

17. An injection-molded plastic hinged closure comprising:
a cap which is fastenable to a neck of a container and which includes a casing, a cover plate adjoining the casing, a retaining skirt protruding from the inner side of the cover plate, and a dispensing opening provided on the cover plate, and
a hinged lid operatively coupled to the cap by means of a joint and which includes a sealing nipple provided on its inner side, the hinged lid is pivotable by means of the joint between a closure position and an open position and which snaps into both the positions, wherein
the hinged lid, the joint, the retaining skirt, and at least a first part of the cover plate are injection-molded from a first plastic and at least the casing is injection-molded from a second plastic, and the first and the second plastics are integrally bonded to one another at their transition.

18. The injection-molded plastic hinged closure according to claim 17, wherein the second plastic is a post-consumer recycled (PCR) plastic.

19. The injection-molded plastic hinged closure according to claim 17, wherein the first plastic is a virgin, non-recycled plastic.

20. The injection-molded plastic hinged closure according to claim 17, wherein the first part of the cover plate is dimensioned such that the retaining skirt lies within the first part, and the joint adjoins the first part.

21. The injection-molded plastic hinged closure according to claim 17, wherein the cover plate comprises a second part which encloses the first part.

22. The injection-molded plastic hinged closure according to claim 21, wherein the second part of the cover plate is injection-molded from the second plastic.

23. The injection-molded plastic hinged closure according to claim 21, wherein the first and the second parts of the cover plate are integrally bonded to one another at their contact point.

24. The injection-molded plastic hinged closure according to claim 21, wherein the first plastic has a first color, and the second plastic has a second color which is different from the first color.

25. The injection-molded plastic hinged closure according to claim 21, wherein the joint is realized by two tension straps and a central connection piece with a length and a width, the first ends of which are integrally formed on the casing and the second ends of which are integrally formed on the hinged lid.

26. The injection-molded plastic hinged closure according to claim 21, wherein the first plastic consists of virgin HDPE or virgin PP.

27. The injection-molded plastic hinged closure according to claim 17, wherein the second plastic consists of a PCR-HDPE or a PCR-PP.

28. A method for producing a hinged closure which is injection-molded from plastic and has:
a cap which is fastenable to a neck of a container and which has a casing, a cover plate adjoining the casing, a retaining skirt protruding from the inner side of the cover plate, and a dispensing opening provided on the cover plate, and
a hinged lid operably coupled to the cap by means of a joint and which has a sealing nipple provided on its inner side, the hinged lid is pivotable by means of the joint between a closure position and an open position and snaps into both the positions,
wherein the hinged lid, the joint, the retaining skirt, and at least a first part of the cover plate are injection-molded from a first plastic and at least the casing is injection-molded from a second plastic, and the first and the second plastics are integrally bonded to one another at their transition, the method comprising:
forming a cavity in an injection mold between a die and a mold core, which cavity constitutes a negative impression of the hinged closure,
retracting a first core retraction insert and a second core retraction insert into a front position to sealingly abut the mold core, thereby preventing filling of a cavity of the hinged lid, the joint, the retaining skirt, and at least a first part of the cover plate,
filling accessible regions of the cavity, which form at least the casing of the hinged closure, are filled with the second molten plastic, whereby at least the casing is injection-molded,
retracting the first and the second core retraction inserts to a rear position, and
filling the unfilled part of the cavity with the first molten plastic, whereby the hinged lid, the joint, the retaining skirt, and at least a first part of the cover plate is injection-molded, and
integrally bonding the first and the second plastics to one another at their common contact point, and
demolding the cured, two-component hinged closure from the injection mold.

29. The method according to claim 28, wherein, immediately after the injection of the second plastic, the two core retraction inserts are moved into the rear position, and, in order to be integrally bonded, the first plastic is injected onto the still hot second plastic immediately after the two core retraction inserts are in the rear position.

30. An injection mold for producing a hinged closure which is injection-molded from plastic and has a cap which is fastenable to a neck of a container and which has a casing, a cover plate adjoining the casing, a retaining skirt protruding from the inner side of the cover plate, and a dispensing opening provided on the cover plate, and
a hinged lid which is operably coupled to the cap by means of a joint and which has a sealing nipple provided on its inner side, which hinged lid is pivotable by means of the joint between a closure position and an open position and snaps into both the positions, wherein the hinged lid, the joint, the retaining skirt, and at least a first part of the cover plate are injection-molded from a first plastic and at least the casing is injection-molded from a second plastic, and the first and the second plastics are integrally bonded to one another at their transition, the injection mold comprising a die, a mold core, and a cavity formed between the die and the core, which cavity constitutes a negative impression of the hinged closure,
a first core retraction insert and a second core retraction insert which are moveable between a front and a rear position and prevent the filling of the cavity of the hinged lid, the joint, the retaining skirt, and at least a part of the cover plate in their front positions.

31. The injection mold according to claim 30, wherein the first core retraction insert in the front position sealingly abuts the mold core.

32. The injection mold according to claim 30, wherein the second core retraction insert in the front position closes the channel between the cavity of the cap and the cavity of the hinged lid, and in the rear position opens said channel.
